(19) United States
(12) Patent Application Publication
(10) Pub. No.: US 2025/0168691 A1
(43) Pub. Date: May 22, 2025

(54) SYSTEMS AND METHODS FOR A FIXED WIRELESS ACCESS ROUTER WITH DIFFERENTIATED ACCESS

(71) Applicant: Verizon Patent and Licensing Inc., Basking Ridge, NJ (US)

(72) Inventors: Jin Yang, Orinda, CA (US); Yong Sang Cho, Old Tappan, NJ (US); Jacob S. Lynch, Sacramento, CA (US); Siksha Bhatia, Dublin, CA (US); Susan Wu Sanders, Bridgewater, NJ (US)

(21) Appl. No.: 18/512,839

(22) Filed: Nov. 17, 2023

(51) Int. Cl. H04W 28/02; H04W 76/10

(52) U.S. Cl. CPC H04W 28/0268; H04W 76/10

(57) ABSTRACT

A device may include a processor configured to receive a data stream connection request via a WIFI connection or a wired connection and establish a cellular wireless connection with a base station based on the data stream connection request. The processor may be further configured to determine a cellular wireless Quality of Service (QOS) class or network slice assigned to the cellular wireless connection by a core network associated with the base station; map the cellular wireless QoS class or network slice to a priority class associated with the WIFI connection or the wired connection; assign the priority class to a data stream associated with the data stream connection request; and process data units associated with the data stream based on the assigned priority class.

### BACKGROUND INFORMATION

To satisfy the needs and demands of users of mobile communication devices, providers of wireless communication services continue to improve and expand their networks. One aspect of such improvements includes the development of wireless access networks that serve customer premises. In order to maintain a quality of service in customer premises, a provider may need to take into account different types of communication services. Managing different types of communication services for customer premises may pose various challenges.

### BRIEF DESCRIPTION OF THE DRAWINGS

FIG. 1 illustrates an environment according to an implementation described herein;

FIG. 2 illustrates exemplary components of device that may be included in a component of an environment according to an implementation described herein;

FIG. 3 illustrates exemplary components of a fixed wireless access according to an implementation described herein;

FIG. 4 illustrates exemplary components of a data streams database according to an implementation described herein;

FIG. 5 illustrates a flowchart for a first process of differentiating services in a fixed wireless access device according to an implementation described herein;

FIG. 6 illustrates a flowchart for a second process of differentiating services in a fixed wireless access device according to an implementation described herein;

FIG. 7 illustrates a first exemplary signal flow according to an implementation described herein; and

FIG. 8 illustrates a second exemplary signal flow according to an implementation described herein.

### DETAILED DESCRIPTION OF EMBODIMENTS

The following detailed description refers to the accompanying drawings. The same reference numbers in different drawings identify the same or similar elements.

A Fifth Generation (5G) New Radio (NR) air interface of a Radio Access Network (RAN) may provide a high data throughput in comparison to the data throughput of a Fourth Generation (4G) Long Term Evolution (LTE) air interface. In order to take advantage of the high bandwidths of the 5G NR air interface, a provider of communication services may deploy fixed wireless access (FWA) devices to provide broadband services, such as an Internet service that includes a Voice over Internet Protocol (VOIP) service, a video streaming service, a live gaming service, an Internet browsing service, etc. Thus, instead of a wired connection (e.g., a coaxial cable connection, etc.) or an optical connection (e.g., an optical network terminal (ONT) connected to an optical fiber, etc.), an FWA device may connect a customer premises equipment (CPE) network to a provider network through one or more base stations via wireless signals. The FWA device may function as a user equipment (UE) device with respect to the one or more base stations. A base station in a RAN may enable the FWA device to connect to a core network managed by the provider.

A CPE network may include a Layer 2 and/or Layer 3 wireless local area network (WLAN) that enables devices to connect to the Internet or other networks. For example, a customer's home may be served by a router managed by a provider of communication services. The router may be connected to, or may function as, a Wireless Fidelity (WIFI) access point (AP) that provides short-range wireless access for devices in the customer's home. Such a device may be referred to as a “WIFI router.” Various devices in the customer's home, such as a laptop computer, a tablet computer device, a mobile phone, and/or a gaming console may connect to the Internet via the WIFI router. WIFI routers operate in WLANs based on the Institute of Electrical and Electronics Engineers (IEEE) 802.11 standards. Such WLANs are referred to as WIFI networks. A FWA device may function as a WIFI router that enables client devices in the CPE network to connect to a base station in a RAN via cellular wireless signals. The RAN may establish a connection from the FWA device to the core network.

A client device may connect to the FWA device via a WIFI connection or a wired connection (e.g., an Ethernet cable, etc.) and request to establish a communication session with a destination device via the provider network. In order to establish a communication session, the FWA device may establish a Protocol Data Unit (PDU) session in the core network via the RAN. The UE device may then establish one or more data flows in the PDU session. Each data flow may be associated with a Quality of Service (QOS) class and/or other types of service requirements. Different QoS classes may be associated with different latency requirements. As another example, a PDU session may be assigned to a network slice. Network slicing is a form of virtual network architecture that enables multiple logical networks to be implemented on top of a common shared physical infrastructure using software defined networking (SDN) and/or network function virtualization (NFV). Each logical network, referred to as a “network slice,” may encompass an end-to-end virtual network with dedicated storage and/or computation resources. Each network slice may be configured to implement a different set of requirements and/or priorities and/or may be associated with a particular QoS class, type of service, security requirement, and/or particular enterprise customer associated with a set of UE devices. For example, a 5G network may include an enhanced Mobile Broadband (eMBB) network slice, an massive Internet of Things (mloT) network slice, an Ultra-Reliable Low Latency Communications (URLLC) network slice, etc.

The QoS class and/or network slice requirements may be maintained by the core network and the RAN. However, outside the core network and RAN, the QoS class and/or network slice requirements may not necessarily be satisfied. For example, the FWA device may not be able to guarantee the requirements within the CPE network, such as in the communication path from the FWA device to the client device via WIFI signals or via a wired connection. For example, the latency from the FWA device to a client device may be higher than a guaranteed latency associated with the QoS class and/or network slice requirements.

Implementations described herein relate to systems and methods for a FWA router device with differentiated access for client devices. A FWA device may differentiate between client device data streams and assign different data streams to different priority classes. The FWA device may include, or be connected to, an accelerator to speed up processing data streams. The FWA device may be configured to receive a data stream connection request from a client device via a WIFI connection or a wired connection and to establish a cellular wireless connection with a base station based on the data stream connection request. The FWA device may be further configured to determine a cellular wireless QoS class or network slice assigned to the cellular wireless connection by a core network associated with the base station; map the cellular wireless QoS class or network slice to a priority class associated with the WIFI connection or the wired connection; assign the priority class to a data stream associated with the data stream connection request; and process data units associated with the data stream based on the assigned priority class.

Processing the data units associated with the data stream based on the assigned priority class may include, for example, assigning the data stream to an Internet Protocol (IP) address associated with the assigned priority class, assigning bandwidth to the data stream based on the assigned priority class, assigning the data stream to a QoS buffer associated with the assigned priority class, assigning a particular transmission power level to the data stream, and/or perform other types of processing to differentiate data streams associated with different priorities. Thus, the FWA device may be configured to assign different priority classes to different data streams associated with different QoS classes and/or different network slices.

Furthermore, the FWA device may include, or be connected with, a hardware accelerator. For example, the FWA device may be configured to detect a trigger condition associated with the data stream, activate the hardware accelerator associated with the device, in response to detecting the trigger condition, and use the hardware accelerator to process data units associated with the data stream. Detecting the trigger condition may include, for example, determining that the cellular wireless QoS class or network slice is associated with a latency requirement that is lower than a latency threshold, determining that the data stream has increased a load associated with the device above a load threshold, receiving a request for a service deployed on the hardware accelerator, and/or detecting another type of trigger condition. In some implementations, services deployed on the hardware accelerator may include Multi-Access Edge Computing (MEC) services associated with the base station.

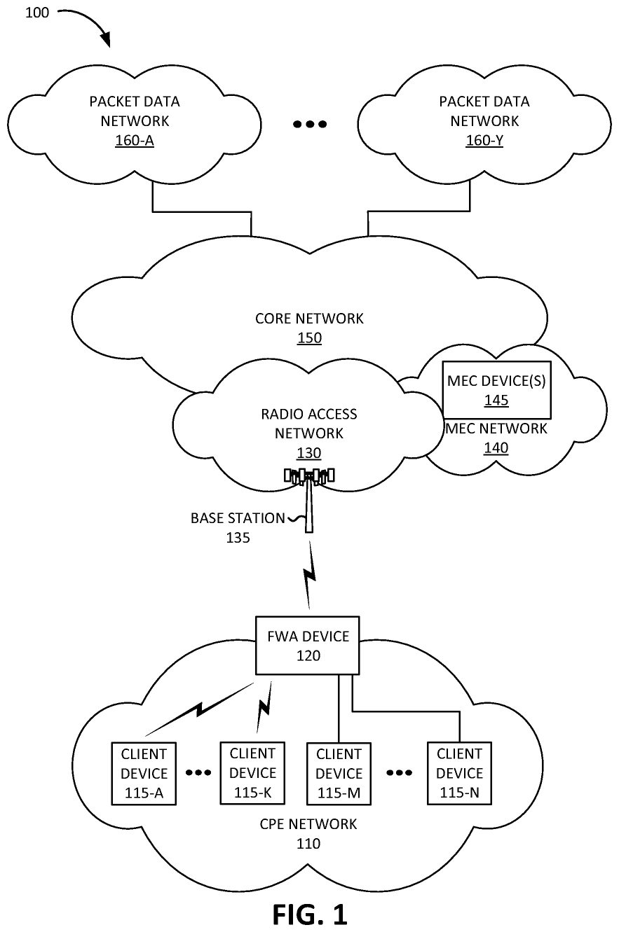

FIG. 1 is a diagram of an exemplary environment 100 in which the systems and/or methods described herein may be implemented. As shown in FIG. 1, environment 100 may include a CPE network 110 that includes client devices 115-A to 115-K and 115-M to 115-N referred to herein collectively as “client devices 115” and individually as “client device 115”) and FWA device 120, a RAN 130 that includes at least one base station 135, a Multi-Access Edge Computing (MEC) network 140 (which includes at least one MEC device 145), a core network 150, and packet data networks (PDNs) 160-A to 160-Y (referred to herein collectively as “PDNs 160” and individually as “PDN 160”).

CPE network 110 may include a Layer 2 and/or Layer 3 local area network (LAN) associated with a customer's premises. For example, CPE network 110 may be located at or within a residential home, in an apartment building, in a school, in a commercial office building, in a shopping mall, in a connected mass transit vehicle (e.g., bus, train, plane, boat, etc.), and/or in another type of location associated with a customer of a provider of telecommunication services.

Client device 115 may include any computer device configured to connect to FWA device 120 using WIFI wireless signals and/or a wired connection (e.g., an Ethernet connection, a Universal Serial Bus (USB) connection, etc.). For example, client device 115 may include a handheld wireless communication device (e.g., a mobile phone, a smart phone, a phablet device, etc.); a wearable computer device (e.g., a head-mounted display computer device, a head-mounted camera device, a wristwatch computer device, etc.); a laptop computer, a tablet computer, or another type of portable computer; a desktop computer; a set-top box or a digital media player (e.g., Apple TV, Google Chromecast, Amazon Fire TV, etc.); a smart television; a gaming system; a home appliance device; a home monitoring device; and/or any other type of computer device with wireless communication capabilities. As another example, client device 115 may correspond to an embedded wireless device that communicates wirelessly with other devices over a machine-to-machine (M2M) interface using Machine Type Communication (MTC) and/or another type of M2M communication. Client device 115 may be used for voice communication, mobile broadband services (e.g., video streaming, video conferencing, real-time gaming, premium Internet access etc.), URLLC services, mloT services, best effort data traffic, and/or other types of services.

FWA device 120 may be installed in a particular location at, or near, the customer premises, such as outside a building (e.g., on a roof, attached to an outside wall, et.) or inside a building (e.g., next to a window or at another location associated with good wireless signal reception). FWA device 120 may be configured to attach to, and communicate with, RAN 130 using cellular wireless signals. For example, FWA device 120 may be configured to communicate via a 5G NR air interface and/or a 4G LTE air interface.

Furthermore, FWA device 120 may function as a WIFI access point (AP) for client devices 115 in CPE network 110. For example, FWA device 120 may include a transceiver configured to communicate with client devices 115-A to 115-K using WIFI signals based on the IEEE 802.11 standards for implementing a WLAN network. Furthermore, FWA device 120 may include one or more wired connections (e.g., Ethernet ports, USB ports, etc.) configured to connect client devices 115-M to 115-N using a wired connection.

FWA device 120 may be configured to function as a switch and/or router for client devices 115 in CPE network 110. For example, FWA device 120 may include a layer 2 and/or layer 3 network device, such as a switch, router, firewall, and/or gateway and may support different types of interfaces, such as an Ethernet interface, a WIFI interface, a Multimedia over Coaxial Alliance (MoCa) interface, a USB interface, and/or other types of interfaces.

FWA device 120 may receive establish a connection for client device 115 with core network 150 via base station 135 in RAN 130. FWA device 120 may assign a priority class to the connection in CPE network 110 to ensure service requirements associated with the connection are satisfied. Thus, FWA device 120 may provide differentiated access for client devices 115. For example, FWA device 120 may provide differentiated access for data streams associated with different cellular wireless QoS classes, different network slices, etc. Additionally, FWA device 120 may include a hardware accelerator. The hardware accelerator may speed up forwarding and/or routing performed by FWA device 120 and/or may host services that may be requested by client devices 115. For example, one or more MEC services deployed on MEC device 145 may also be deployed on the hardware accelerator.

RAN 130 may include one or more base stations 135. Base station 135 may be configured for one or more Radio Access Technology (RAT) types. For example, base station 120 may include a 5G NR base station (e.g., a gNodeB) and/or a 4G LTE base station (e.g., an eNodeB). Base station 135 may enable FWA device 120 to communicate with core network 150 using cellular wireless signals. Base station 135 may include devices and/or components that enable cellular wireless communication with FWA device 120. For example, base station 135 may include a set of sectors (e.g., 120° sectors, 90° sectors, etc.) and each sector may include an RF transceiver configured to communicate with UE devices using a 5G NR air interface, a 4G LTE air interface, and/or using another type of cellular air interface.

MEC network 140 may be associated with base station 135 and may provide MEC services for UE devices attached to base station 135, such as FWA device 120. MEC network 140 may be in proximity to base station 135 from a geographic and network topology perspective, thus enabling low latency services to be provided to client devices 115 via FWA device 120. As an example, MEC network 140 may be located on the same site as base station 135. As another example, MEC network 140 may be geographically closer to base station 135 and reachable via fewer network hops and/or fewer switches, than other base stations 135.

MEC network 140 may include one or more MEC devices 145. MEC devices 145 may provide MEC services to client devices 115 via FWA device 120. A MEC service may include, for example, a low-latency microservice associated with a particular application, a microservice associated with a virtualized network function (VNF) of core network 150, a cloud computing service, such as cache storage service, artificial intelligence (AI) accelerator service, machine learning service, an image processing service, a data compression service, a locally centralized gaming service, a Graphics Processing Units (GPUs) and/or other types of hardware accelerator service, and/or other types of cloud computing services. One or more MEC services deployed on MEC device 145 may be also deployed locally in CPE network 110 on a hardware accelerator associated with FWA device 120.

Core network 150 may be managed by a provider of cellular wireless communication services and may manage communication sessions of subscribers connecting to core network 150 via RAN 130. For example, core network 150 may establish an Internet Protocol (IP) connection between client devices 115 and PDN 160 via FWA device 120. In some implementations, core network 150 may include a 5G core network. In other implementations, core network 150 may include a 4G core network (e.g., an evolved packet core (EPC) network) and/or another type of core network.

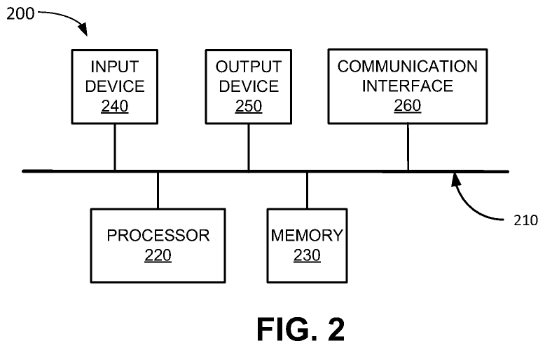

The components of core network 150 may be implemented as dedicated hardware components or as virtualized functions implemented on top of a common shared physical infrastructure using SDN. For example, an SDN controller may implement one or more of the components of core network 150 using an adapter implementing a VNF virtual machine, a Cloud Native Function (CNF) container, an event driven serverless architecture interface, and/or another type of SDN component. The common shared physical infrastructure may be implemented using one or more devices 200 described below with reference to FIG. 2 in a cloud computing center associated with core network 150. Additionally, or alternatively, some, or all, of the shared physical infrastructure may be implemented using one or more devices 200 implemented in MEC device 145 in MEC network 140.

PDNs 160-A to 160-Y may each be associated with a Data Network Name (DNN) in 5G, and/or an Access Point Name (APN) in 4G. Client device 115 may request, via FWA device 120, a connection to PDN 160 using a DNN or an APN. PDN 160 may include, and/or be connected to, a local area network (LAN), a wide area network (WAN), a metropolitan area network (MAN), an autonomous system (AS) on the Internet, an optical network, a cable television network, a satellite network, a wireless network (e.g., a CDMA network, a general packet radio service (GPRS) network, and/or an LTE network), an ad hoc network, a telephone network (e.g., the Public Switched Telephone Network (PSTN) or a cellular network), an intranet, or a combination of networks.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

FIG. 2 illustrates example components of a device 200 according to an implementation described herein. Client device 115, FWA device 120, base station 135, MEC device 145, and/or other components of core network 150, RAN 130, or CPE network 110, may each include one or more devices 200. As shown in FIG. 2, device 200 may include a bus 210, a processor 220, a memory 230, an input device 240, an output device 250, and a communication interface 260.

Bus 210 may include a path that permits communication among the components of device 200. Processor 220 may include any type of single-core processor, multi-core processor, microprocessor, latch-based processor, central processing unit (CPU), and/or processing logic (or families of processors, microprocessors, and/or processing logics) that interprets and executes instructions. In other embodiments, processor 220 may include an application-specific integrated circuit (ASIC), a field-programmable gate array (FPGA), and/or another type of integrated circuit or processing logic. Additionally, or alternatively, processor 220 may include a hardware accelerator integrated circuit or processing logic, such as a GPU, a tensor processing unit (TPU), quantum annealing unit, quantum computer unit, and/or another type of hardware accelerator.

Memory 230 may include any type of dynamic storage device that may store information and/or instructions, for execution by processor 220, and/or any type of non-volatile storage device that may store information for use by processor 220. For example, memory 230 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 240 may allow an operator to input information into device 200. Input device 240 may include, for example, a keyboard, a mouse, a pen, a microphone, a remote control, an audio capture device, an image and/or video capture device, a touch-screen display, and/or another type of input device. In some embodiments, device 200 may be managed remotely and may not include input device 240. In other words, device 200 may be “headless” and may not include a keyboard, for example.

Output device 250 may output information to an operator of device 200. Output device 250 may include a display, a printer, a speaker, and/or another type of output device. For example, device 200 may include a display, which may include a liquid-crystal display (LCD) for displaying content to the customer. In some embodiments, device 200 may be managed remotely and may not include output device 250. In other words, device 200 may be “headless” and may not include a display, for example.

Communication interface 260 may include a transceiver that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to RF signals and/or a receiver that converts RF signals to baseband signals. Communication interface 260 may be coupled to one or more antennas/antenna arrays for transmitting and receiving RF signals.

Communication interface 260 may include a logical component that includes input and/or output ports, input and/or output systems, and/or other input and output components that facilitate the transmission of data to other devices. For example, communication interface 260 may include a network interface card (e.g., Ethernet card) for wired communications and/or a wireless network interface (e.g., a WIFI) card for wireless communications. Communication interface 260 may also include USB port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 200 may perform certain operations relating to providing differentiated access services associated with different cellular wireless QoS classes, network slices, and/or other types of differentiated cellular services. Device 200 may perform these operations in response to processor 220 executing software instructions contained in a computer-readable medium, such as memory 230. A computer-readable medium may be defined as a non-transitory memory device. A memory device may be implemented within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, additional components, or differently arranged components than depicted in FIG. 2. Additionally, or alternatively, one or more components of device 200 may perform one or more tasks described as being performed by one or more other components of device 200.

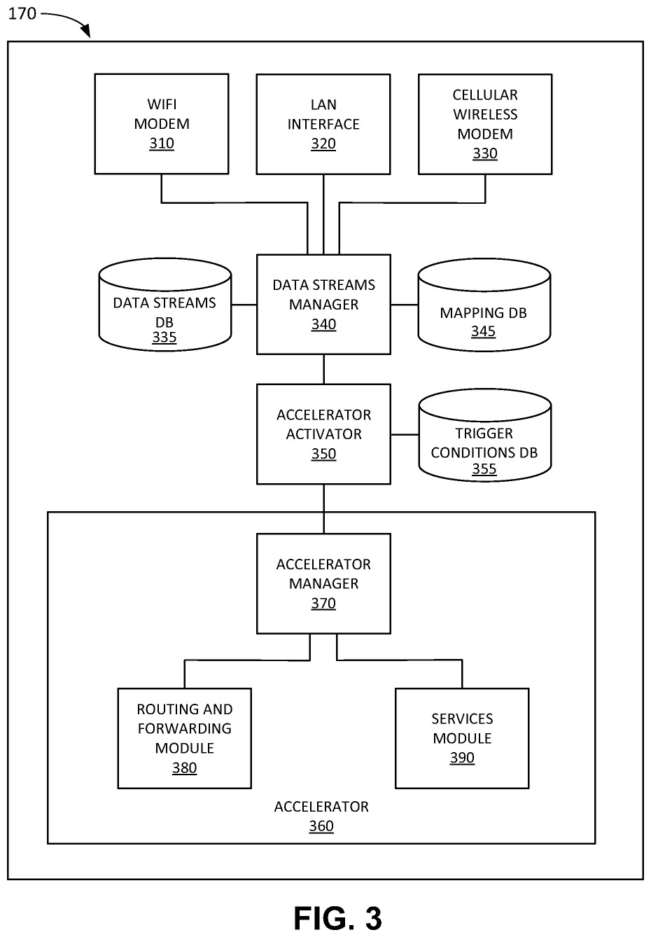

FIG. 3 is a diagram illustrating exemplary components of FWA device 120. The components of FWA device 120 may be implemented via processor 220 executing instructions from memory 230. For example, a component of FWA device 120 may correspond to the structure of processor 220 together with instructions in memory 230 for implementing the functionality of the component. Alternatively, or additionally, some or all of the components of FWA device 120 may be implemented via hard-wired circuitry. For example, a component of FWA device 120 may correspond to the structure of some or all of an ASIC, FPGA, and/or another type of integrated circuit. As shown in FIG. 3, FWA device 120 may include a WIFI modem 310, a LAN interface 320, a cellular wireless modem 330, a data streams database (DB) 335, a data streams manager 340, a mapping DB 345, an accelerator activator 350, a trigger conditions DB 355, and an accelerator 360.

WIFI modem 310 may be configured to implement WIFI communication with client devices 115 based on the IEEE 802.11 set of standards for wireless communication. LAN interface 320 may be configured to implement LAN communication over a wired connection (e.g., Ethernet communication, etc.) and/or other type of wired communication, such as, for example, communication via a USB interface. Cellular wireless modem 330 may be configured to implement cellular wireless communication with base station 135. For example, cellular wireless modem 330 may implement cellular wireless communication using a 5G NR air interface, a 4G LTE air interface, and/or using another type of cellular wireless interface.

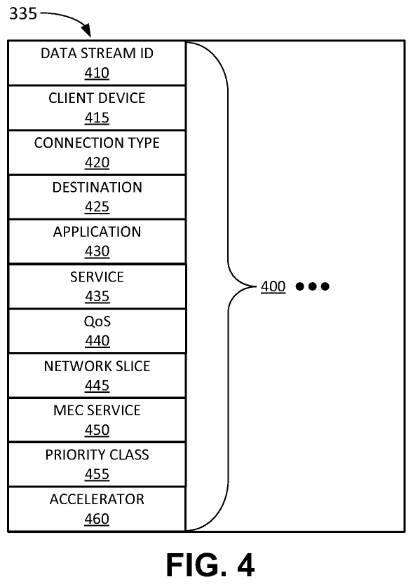

Data streams DB 335 may store information relating to data streams between client devices 115 and base station 135 managed by FWA device 120. Exemplary information that may be stored in data streams DB 335 is described below with reference to FIG. 4. Data streams manager 340 may manage data streams between client devices 115 and base station 135. For example, data streams manager 340 may receive a data stream connection request from client device 115 via a WIFI connection or a wired connection and send a PDU session establishment request to base station 135. The data stream connection request may include information that enables data streams manager 340 to request a QoS class, a network slice, and/or a MEC service based on information stored in mapping DB 345 and/or information stored in cellular wireless modem 330, such as, for example, a UE route selection policy (URSP).

For example, mapping DB 345 may relate particular priority defining parameters to cellular wireless QoS classes, network slices, and/or MEC services. A priority defining parameter may include an application identifier (ID), such as, for example, a gaming application ID, a video conferencing application ID, a video streaming application ID, a mixed reality (XR) application ID, etc.; a particular application label associated with an application, wherein an application may be associated with multiple application labels with different requirements; a destination of a data stream, such as, for example, a DNN, an APN, a domain name, a Uniform Resource Locator (URL), an application server IP address, etc.; an IP header value, such as, for example, a Differentiated Services Code Point (DSCP) value, an Explicit Congestion Notification (ECN) value, etc.; a device ID associated with client device 115 requesting the data stream, such as, for example, a Media Access Control (MAC) address, a Mobile Directory Number (MDN), an International Mobile Subscriber Identity (IMSI), a Mobile Station International Subscriber Directory Number (MSISDN), an International Mobile Equipment Identity (IMEI), etc.; a device group subscription number associated with client device 115 requesting the data stream; and/or another type of priority defining parameter.

In some implementations, data streams manager 340 may map the priority defining parameter to a cellular wireless QoS class ID, such as, for example, a 5G QoS class identifier (5QI), to a network slice ID, such as, for example, a Network Slice Selection Assistance Information (NSSAI), or a MEC service ID deployed on MEC device 145. Data streams manager 340 may include the cellular wireless QoS class ID, network slice ID, and/or MEC service ID in the PDU session establishment message sent to base station 135. In other implementations, data streams manager 340 may send a PDU session establishment request to base station 135 without mapping a priority defining parameter to a cellular wireless QoS class ID, network slice ID, and/or MEC service ID, and core network 150 may select the cellular wireless QoS class ID, network slice ID, and/or MEC service ID based on information included in the data stream request (e.g., application ID, etc.). Base station 135 may respond with a PDU session establishment accept message that includes information identifying a cellular wireless QoS class ID, network slice ID, and/or MEC service ID assigned to the PDU session established based on the PDU session establishment request.

In some situations, the cellular wireless QoS class ID, network slice ID, and/or MEC service ID assigned to the PDU session by core network 150 may be different from the requested cellular wireless QoS class ID, network slice ID, and/or MEC service ID. For example, client device 115 may be not allowed on a requested cellular wireless QoS class ID, network slice ID, and/or MEC service ID; the requested cellular wireless QoS class ID, network slice ID, and/or MEC service ID may not be available; a more appropriate or newly deployed cellular wireless QoS class ID, network slice ID, and/or MEC service ID may be available to better satisfy the PDU session requirements, etc.

Data streams manager 340 may map the assigned cellular wireless QoS class ID, network slice ID, and/or MEC service ID to a WIFI or LAN priority class based on a mapping stored in mapping DB 345 and then process data units associated with the data stream in CPE network 110 based on the assigned WIFI or LAN priority class. For example, data streams manager 340 may assign the data stream to an IP address associated with the assigned priority class, assign bandwidth and/or a frequency band to the data stream based on the assigned priority class, assign time slots in a time division multiplexing schedule based on the assigned priority class, assign the data stream to a QoS buffer associated with the assigned priority class, assign a transmission power level to the data stream based on the assigned priority class, and/or perform other types of processing to differentiate data streams associated with different priorities.

In other implementations, data streams manager 340 may map the priority defining parameter to a WIFI or LAN priority class first, map the assigned WIFI or LAN priority class to a cellular wireless QoS class ID, network slice ID, and/or MEC service ID, and send a PDU session establishment request to base station 135 using the mapped cellular wireless QoS class ID, network slice ID, and/or MEC service ID. Base station 135 may respond with a PDU session establishment accept message that includes information identifying a cellular wireless QoS class ID, network slice ID, and/or MEC service ID assigned to the PDU session established based on the PDU session establishment request. Data streams manager 340 may adjust the selected priority class based on the assigned cellular wireless QoS class ID, network slice ID, and/or MEC service ID.

Thus, data streams manager 340 may be configured to assign different priority classes to different data streams associated with different QoS classes and/or different network slices. As an example, data streams manager 340 may establish a second cellular wireless connection with base station 135 for a second data stream associated with a second WIFI or wired connection, wherein the second cellular wireless connection is assigned to a second cellular wireless QoS class different from a first cellular wireless QoS class associated with a first WIFI or wired connection, and assign the second data stream to a second priority class based on the second cellular wireless QoS class, wherein the second priority is different from a first priority class assigned to the first WIFI or wired connection. As another example, data streams manager 340 may establish a second cellular wireless connection with base station 135 for a second data stream associated with a second WIFI or wired connection, wherein the second cellular wireless connection is assigned to a second network slice different from a first network slice associated with a first WIFI or wired connection, and assign the second data stream to a second priority class based on the second network slice, wherein the second priority is different from a first priority class assigned to the first WIFI or wired connection.

Accelerator activator 350 may determine whether to activate accelerator 360 based on trigger conditions stored in trigger conditions DB 355. The set of trigger conditions stored in trigger conditions DB 355 may include, for example, the establishment of a data stream assigned to a particular priority class, the establishment of a PDU session assigned a particular cellular wireless QoS class ID, network slice ID, and/or MEC service ID; determining a PDU session is associated with a latency requirement that is lower than a latency threshold; determining that a load associated with FWA device 120 is above a load threshold; determining that a request for a service deployed on accelerator 360 has been detected; and/or another type of trigger condition. If accelerator activator 350 detects a trigger condition, accelerator activator 350 may activate accelerator 360 and may process data units associated with one or more data streams using accelerator 360.

Accelerator 360 may include a hardware accelerator that includes one or more GPUs, TPUs, CPUs, ASIC artificial intelligence (AI) accelerators, Transmission Control Protocol (TCP) offload engines, cryptographic accelerators, and/or other types of hardware accelerators to speed up processing of data streams and/or services requested via a data stream. In some implementations, accelerator 360 may be embedded in FWA device 120. In other implementations, accelerator 360 may be included in a separate box that may be connected to FWA device 120.

Accelerator 360 may include an accelerator manager 370, a routing and forwarding module 380, and a services module 390. Accelerator manager 370 may distribute workload of accelerator 360 and manage process threads associated with data streams managed by FWA device 120. Routing and forwarding module 380 may include specialized hardware to speed up processing of routing and forwarding of data units between different client devices 115 and/or between client device 115 and base station 135.

Services module 390 may host one or more services that may be provided to client devices 115. The services may include, for example, a low-latency microservice associated with a particular application, a cache storage service, a cloud computing service, a locally centralized gaming service, an image processing service, a cryptographic service, a machine learning service, and/or another type of service requiring a large amount of processing power, storage space, and/or low latency. In some implementations, the services may include locally deployed versions of one or more MEC services available in MEC network 140.

Although FIG. 3 shows exemplary components of FWA device 120, in other implementations, FWA device 120 may include fewer components, different components, additional components, or differently arranged components than depicted in FIG. 3. Additionally, or alternatively, one or more components of FWA device 120 may perform one or more tasks described as being performed by one or more other components of FWA device 120.

FIG. 4 illustrates exemplary components of data streams DB 335. As shown in FIG. 4, data streams DB 335 may include one or more data stream records 400. Each data stream record 400 may store information associated with a particular data stream managed by FWA device 120. Sector record 400 may include a data stream ID field 410, a client device field 415, a connection type field 420, a destination field 425, an application field 430, a service field 435, a QoS field 440, a network slice field 445, a MEC service field 450, a priority class field 455, and an accelerator field 460.

Data stream ID field 410 may store an ID associated with a particular data stream. Client device field 415 may store an ID associated with client device 115 corresponding to an endpoint of the particular data stream, such as, for example, a MAC address, a WIFI network client device ID, an IMSI, an MDN, an MSISDN, an IMEI, and/or another type of ID associated with client device 115. Connection type field 420 may identify a connection type associated with the data stream, such as whether the connection corresponds to a WIFI connection or a wired connection.

Destination field 425 may identify a destination associated with the data stream, such as, for example, a DNN, an APN, a domain name, a URL, IP address, and/or another type of ID associated with the destination. Application field 430 may store information identifying an application, on client device 115, associated with the particular data stream. Service field 435 may store information indicating whether the data stream has requested, or is associated with, a service hosted on accelerator 360.

QoS field 440 may store information identifying a cellular wireless QoS class assigned to a PDU session associated with the data stream. For example, QoS field 440 may store a 5QI value associated with the PDU session. Network slice field 445 may store information identifying a network slice assigned to the PDU session associated with the data stream. For example, network slice field 445 may store a single NSSAI (S-NSSAI) value associated with the PDU session. MEC service 450 may store information indicating whether the PDU session associated with the data stream is associated with a MEC service and may store a MEC service ID if the data stream is associated with a MEC service. Priority class field 455 may store information identifying a WIFI or LAN priority class assigned to the data stream by data streams manager 340. Accelerator field 460 may store information indicating whether accelerator 360 is to be activated for the data stream.

Although FIG. 4 shows exemplary components of data streams DB 335, in other implementations, data streams DB 335 may include fewer components, different components, additional components, or differently arranged components than depicted in FIG. 4.

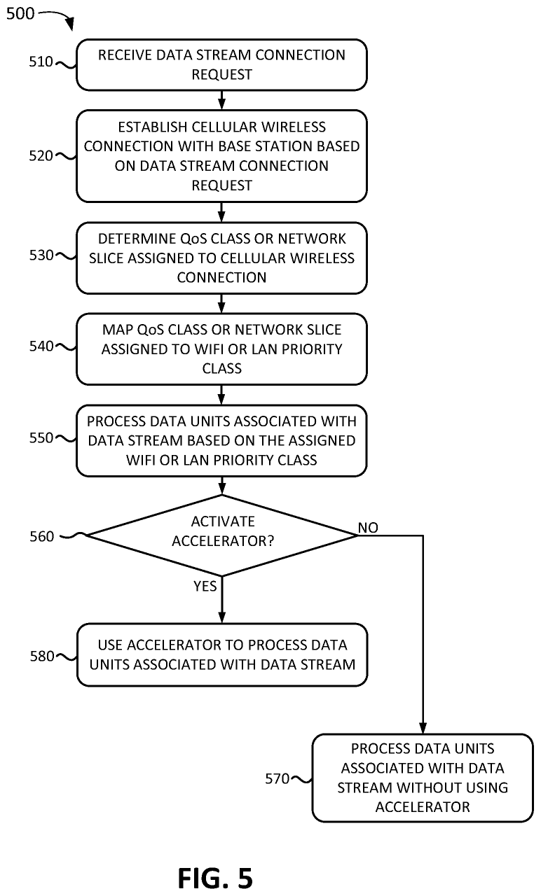

FIG. 5 illustrates a flowchart for a process 500 of differentiating services in a fixed wireless access device. In some implementations, process 500 may be performed by FWA device 120. In other implementations, some or all of process 500 may be performed by another device or a group of devices.

As shown in FIG. 5, process 500 may include receiving a data stream connection request (block 510) and establishing a cellular wireless connection with a base station based on the data stream connection request (block 520). For example, FWA device 120 may receive a data stream connection request from client device 115 via a WIFI connection or a wired connection and send a PDU session establishment request to base station 135 based on the received data stream connection request. The data stream connection request may include information that enables FWA device 120 to request a particular cellular wireless QoS class, a network slice, and/or a MEC service, such as, for example, an application ID, an application label, a destination for the data stream, an IP header value, a device ID associated with client device 115, a device group ID associated with client device 115, and/or another priority defining parameter. In some implementations, FWA device 120 may map the priority defining parameter to a cellular wireless QoS class, network slice, and/or a MEC service and request the cellular wireless QoS class, network slice, and/or MEC service in the PDU session establishment request. In other implementations, FWA device 120 may send the PDU session establishment request to base station 135 without mapping a priority defining parameter to a cellular wireless QoS class, network slice, and/or a MEC service and core network 150 may assign a cellular wireless QoS class, network slice, and/or MEC service to the PDU session based on other information included in the PDU session establishment request.

Process 500 may further include determining a QoS class or network slice assigned to the cellular wireless connection (block 530), mapping the QoS class or network slice to a WIFI or LAN priority class (block 540), and processing data units associated with the data stream based on the assigned WIFI or LAN priority class (block 550). For example, FWA device 120 may receive a PDU session establishment accept message from base station 135, indicating that the PDU session has been established. The PDU session establishment accept message may include information identifying a cellular wireless QoS class, network slice, and/or MEC service assigned to the PDU session by core network 150.

FWA device 120 may map the assigned cellular wireless QoS class, network slice, and/or MEC service to a WIFI or LAN priority class using mapping DB 345. As an example, a cellular wireless QoS class with a low latency requirement may be mapped to low latency priority class. As another example, a cellular wireless QoS class with a high throughput requirement may be mapped to a high throughput priority class. As yet another example, a cellular wireless QoS class with a high reliability requirement may be mapped to a high reliability priority class. As yet another example, if the PDU session is associated with a MEC service, the cellular wireless QoS class may be mapped to low latency priority class.

FWA device 120 may then process data units associated with the data stream based on the mapped WIFI or LAN priority class. For example, FWA device 120 may assign the data stream to an IP address associated with the assigned priority class, assign bandwidth and/or a frequency band to the data stream based on the assigned priority class, assign time slots in a time division multiplexing schedule based on the assigned priority class, assign the data stream to a QoS buffer associated with the assigned priority class, assign a transmission power level to the data stream based on the assigned priority class, and/or perform other types of processing to differentiate data streams associated with different priorities.

As an example, data units assigned to a low latency priority class may be processed before data units assigned to a priority class associated with a higher latency. As another example, data units assigned to a high throughput priority class may be processed at a higher bandwidth, such as, for example, by using a frequency channel with a higher throughput, by using multiple frequency channels, by using a higher number of time slots in a time division multiplexing schedule, etc. As yet another example, data units assigned to a high reliability priority class may be processed using a higher transmission power than a priority class associated with a lower reliability.

Process 500 may further include determining whether to activate an accelerator (block 560). FWA device 120 may determine whether a trigger condition for the data stream is satisfied using trigger conditions DB 355. For example, FWA device 120 may determine whether the data stream has been assigned to a particular priority class; whether the PDU session associated with the data stream has been assigned to a particular cellular wireless QoS class ID, network slice ID, and/or MEC service ID; whether the PDU session is associated with a latency requirement that is lower than a latency threshold; whether a load associated with FWA device 120 is above a load threshold; whether the data stream is associated with a request for a service deployed on accelerator 360, etc.

If it is determined not to activate the accelerator (block 560-NO), data units associated with the data stream may be processed without using the accelerator (block 570). If it is determined to activate the accelerator (block 560-YES), the accelerator may be used to process data units associated with the data stream (block 580). For example, FWA device 120 may activate accelerator 360 and accelerator 360 may start processing data units associated with the data stream and/or may activate a service deployed on accelerator 360 for the data stream.

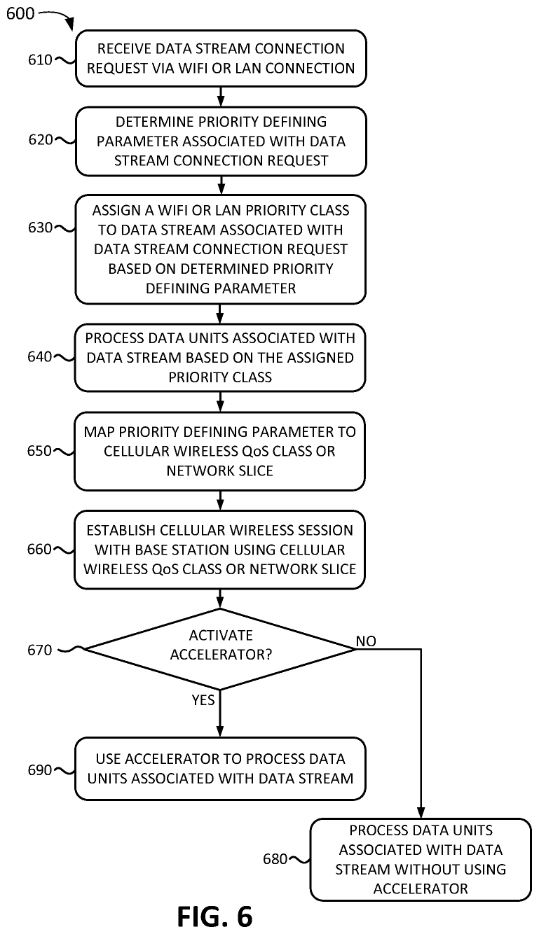

FIG. 6 illustrates a flowchart for a process 600 of differentiating services in a fixed wireless access device. In some implementations, process 600 may be performed by FWA device 120. In other implementations, some or all of process 600 may be performed by another device or a group of devices. In process 600, a WIFI or LAN priority class may be assigned first and then mapped to a cellular wireless QoS class, network slice, and/or MEC service.

As shown in FIG. 6, process 600 may include receiving a data stream connection request via a WIFI or LAN connection (block 610), determining a priority defining parameter associated with the data stream connection request (block 620), assigning a WIFI or LAN priority class to a data stream associated with the data stream connection request based on the determined priority defining parameter (block 630), and processing data units associated with the data stream based on the assigned priority class (block 640).

For example, FWA device 120 may receive a data stream connection request from client device 115 via a WIFI connection or a wired connection and send a PDU session establishment request to base station 135 based on the received data stream connection request. The data stream connection request may include a priority defining parameter, such as, for example, an application ID, an application label, a destination for the data stream, an IP header value, a device ID associated with client device 115, a device group ID associated with client device 115, and/or another priority defining parameter. FWA device 120 may map the priority defining parameter to a WIFI or LAN priority class.

As an example, an application ID or destination associated with a low latency requirement may be mapped to low latency priority class. As another example, an application ID or destination associated with a high throughput requirement may be mapped to a high throughput priority class. As yet another example, an application ID or destination associated with a high reliability requirement may be mapped to a high reliability priority class. FWA device 120 may then process data units associated with the data stream based on the mapped WIFI or LAN priority class, as described above with reference to block 550.

Process 600 may further include mapping the priority defining parameter to a cellular wireless QoS class or network slice (block 650) and establishing a cellular wireless session with a base station using the cellular wireless QoS class or network slice (block 660). For example, FWA device 120 may map the priority defining parameter to a cellular wireless QoS class, network slice, and/or a MEC service and send a PDU session establishment request to base station 135 that includes a request for the mapped cellular wireless QoS class, network slice, and/or MEC service. Base station 135 may respond with a PDU session establishment accept message, indicating that the PDU session has been established. The PDU session establishment accept message may include information identifying a cellular wireless QoS class, network slice, and/or MEC service assigned to the PDU session by core network 150.

Process 600 may further include determining whether to activate an accelerator (block 670). FWA device 120 may determine whether a trigger condition for the data stream is satisfied as described above with reference to block 560. If it is determined not to activate the accelerator (block 670-NO), data units associated with the data stream may be processed without using the accelerator (block 680). If it is determined to activate the accelerator (block 670-YES), the accelerator may be used to process data units associated with the data stream (block 690). For example, FWA device 120 may activate accelerator 360 and accelerator 360 may start processing data units associated with the data stream and/or may activate a service deployed on accelerator 360 for the data stream.

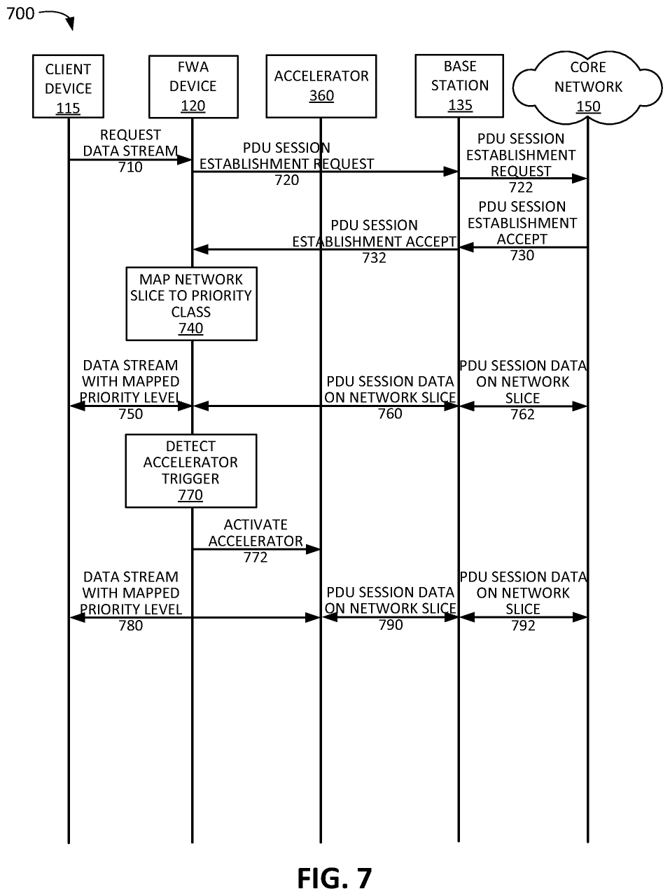

FIG. 7 illustrates an exemplary signal flow 700. As shown in FIG. 7, signal flow 700 may include client device 115 sending a data stream request to FWA device 120 via WIFI (signal 710). Assume the data stream request is a request to connect to a real-time gaming service hosted by an application server in PDN 160. FWA device 120 may send a PDU session establishment request to base station 135 based on the received data stream connection request (signal 720). The PDU session establishment request may include a request for a gaming network slice, or may include information that enables core network 150 to select the gaming network slice, such as a game application ID.

Base station 135 may forward the PDU session establishment request to core network 150 (signal 722). Core network 150 may establish the PDU session for client device 115 to a DNN, associated with PDN 160, and may assign the PDU session to the gaming network slice. Core network 150 may respond with a PDU session establishment accept message with information identifying that the PDU session has been assigned to the gaming network slice (signal 730) and base station 35 may forward the PDU session establishment accept message to FWA device 120 (signal 732).

FWA device 120 may map a gaming network slice ID associated with the gaming network slice to a WIFI real-time gaming priority class (block 740). Data units of the data stream may be processed in CPE network 110 between client device 115 and FWA device 120 over WIFI based on the WIFI real-time gaming priority class (signal 750) and the PDU session between FWA device 120 and core network 150 may be processed on the gaming network slice (signals 760 and 762).

At a later time, FWA device 120 may detect an accelerator trigger (block 770). As an example, the load of FWA device 120 may increase above a load threshold. For example, the number of data session associated with client devices 115 being processed by FWA device 120 may increase the processor load of FWA device 120 above a processor load threshold. In response, FWA device 120 may activate accelerator 360 (signal 772). Accelerator 360 may take over processing for at least some of the data streams being processed by FWA device 120. As a result, data units of the data stream may be processed in CPE network 110 between client device 115 and accelerator 360 over WIFI based on the WIFI real-time gaming priority class (signal 780) and the PDU session between accelerator 360 and core network 150 may be processed on the gaming network slice (signals 790 and 792).

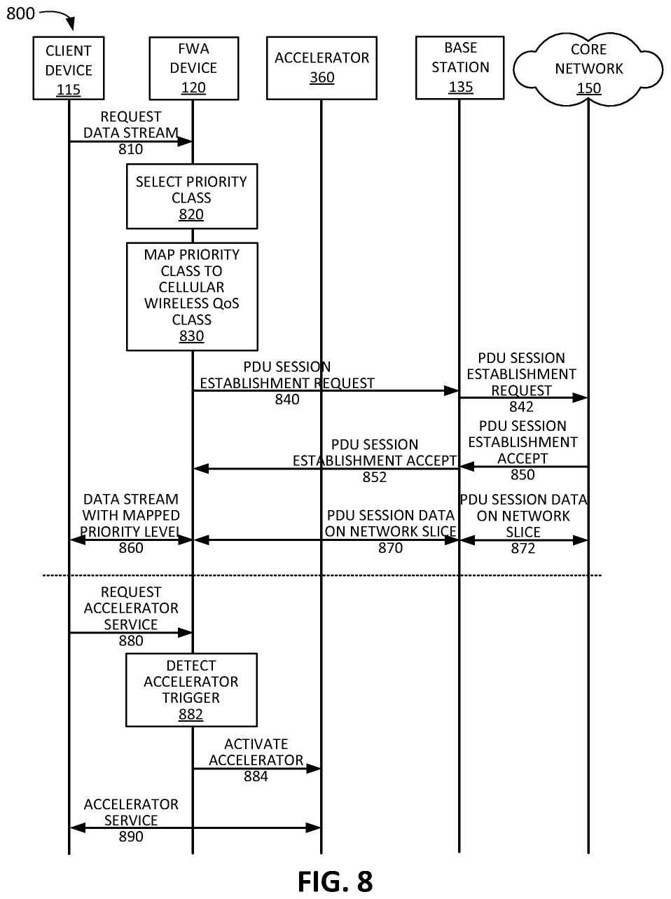

FIG. 8 illustrates an exemplary signal flow 800. In signal flow 800, a WIFI or LAN priority class may be assigned first and then mapped to a cellular wireless QoS class, network slice, and/or MEC service. As shown in FIG. 8, signal flow 800 may include client device 115 sending a data stream request to FWA device 120 via a wired LAN connection (signal 810). Assume the data stream request is a request to upload a real-time video stream to an application server in PDN 160. FWA device 120 may detect an application ID associated with a video streaming application and may select a LAN real-time video priority class (block 820). FWA device 120 may then map the LAN real-time video priority class to a 5QI associated with real-time video streaming (block 830).

FWA device 120 may then send a PDU session establishment request to base station 135. The PDU session establishment request may include a request for a PDU session with a data flow assigned to the mapped 5QI (signal 840). Base station 135 may forward the PDU session establishment request to core network 150 (signal 842). Core network 150 may establish the PDU session for client device 115 to a DNN, associated with PDN 160, and may create a data flow in the PDU with the mapped 5QI. Core network 150 may respond with a PDU session establishment accept message with information identifying that the PDU session has been created and that a data flow with the 5QI has been created in the PDU session (signal 850) and base station 35 may forward the PDU session establishment accept message to FWA device 120 (signal 852). Data units of the data stream may be processed in CPE network 110 between client device 115 and FWA device 120 over WIFI based on the LAN real-time video priority class (signal 860) and the data units may be sent via the 5QI data flow in the PDU session between FWA device 120 and core network 150 (signals 870 and 872).

At a later time, client device 115 may request a video processing machine learning service, such as an object recognition service, to label objects in real-time in the video stream, that is available via accelerator 360 (signal 880). In response, FWA device 120 may detect an activation trigger for accelerator 360 (block 882) and activate accelerator 360 (signal 884). Data units may be exchanged between client device 115 and accelerator 360 to perform the object recognition service on video frames associated with the video stream being streamed by client device 115 (signal 890).

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIGS. 5 and 6, and a series of signals have been described with respect to FIGS. 7 and 8, the order of the blocks and/or signals may be modified in other implementations. Further, non-dependent blocks and/or signals may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
receiving, by a device, a data stream connection request via a WIFI connection or a wired connection;
establishing, by the device, a cellular wireless connection with a base station based on the data stream connection request;
determining, by the device, a cellular wireless Quality of Service (QOS) class or network slice assigned to the cellular wireless connection by a core network associated with the base station;
mapping, by the device, the cellular wireless QoS class or network slice to a priority class associated with the WIFI connection or the wired connection;
assigning, by the device, the priority class to a data stream associated with the data stream connection request; and
processing, by the device, data units associated with the data stream based on the assigned priority class.

2. The method of claim 1, wherein the device includes a Fixed Wireless Access (FWA) device.

3. The method of claim 1, wherein processing the data units associated with the data stream based on the assigned priority class includes:
assigning the data stream to an Internet Protocol (IP) address associated with the assigned priority class.

4. The method of claim 1, wherein processing the data units associated with the data stream based on the assigned priority class includes at least one of:
assigning a bandwidth to the data stream based on the assigned priority class, or
assigning the data stream to a QoS buffer associated with the assigned priority class.

5. The method of claim 1, wherein the data stream is assigned to the cellular wireless QoS class, the method further comprising:
establishing a second cellular wireless connection with the base station for a second data stream associated with a second WIFI or wired connection, wherein the second cellular wireless connection is assigned to a second cellular wireless QoS class different from the cellular wireless QoS class; and
assigning the second data stream to a second priority class based on the second cellular wireless QoS class, wherein the second priority class is different from the priority class.

6. The method of claim 1, wherein the data stream is assigned to the network slice, the method further comprising:
establishing a second cellular wireless connection with the base station for a second data stream associated with a second WIFI or wired connection, wherein the second cellular wireless connection is assigned to a second network slice different from the network slice; and
assigning the second data stream to a second priority class based on the second network slice, wherein the second priority is different from the priority class.

7. The method of claim 1, further comprising:
detecting a trigger condition associated with the data stream;
activating a hardware accelerator associated with the device, in response to detecting the trigger condition; and
using the hardware accelerator to process data units associated with the data stream.

8. The method of claim 7, wherein detecting the trigger condition associated with the data stream includes:
determining that the cellular wireless QoS class or network slice is associated with a latency requirement that is lower than a latency threshold.

9. The method of claim 7, wherein detecting the trigger condition associated with the data stream includes:
determining that the data stream has increased a load associated with the device above a load threshold.

10. The method of claim 7, wherein detecting the trigger condition associated with the data stream includes:
receiving a request for a service deployed on the hardware accelerator.

11. The method of claim 10, wherein the service deployed on the hardware accelerator includes a Multi-Access Edge Computing (MEC) service associated with the base station.

12. A device comprising:
a processor configured to:
receive a data stream connection request via a WIFI connection or a wired connection;
establish a cellular wireless connection with a base station based on the data stream connection request;
determine a cellular wireless Quality of Service (QOS) class or network slice assigned to the cellular wireless connection by a core network associated with the base station;
map the cellular wireless QoS class or network slice to a priority class associated with the WIFI connection or the wired connection;
assign the priority class to a data stream associated with the data stream connection request; and
process data units associated with the data stream based on the assigned priority class.

13. The device of claim 12, wherein the device includes a Fixed Wireless Access (FWA) device.

14. The device of claim 12, wherein, when processing the data units associated with the data stream based on the assigned priority class, the processor is further configured to:
assign the data stream to an Internet Protocol (IP) address associated with the assigned priority class.

15. The device of claim 12, wherein the processor is further configured to:
detect a trigger condition associated with the data stream;
activate a hardware accelerator associated with the device, in response to detecting the trigger condition; and
use the hardware accelerator to process data units associated with the data stream.

16. The device of claim 15, wherein, when detecting the trigger condition associated with the data stream, the processor is further configured to:
determine that the cellular wireless QoS class or network slice is associated with a latency requirement that is lower than a latency threshold.

17. The device of claim 15, wherein, when detecting the trigger condition associated with the data stream, the processor is further configured to:
determine that the data stream has increased a load associated with the device above a load threshold.

18. The device of claim 15, wherein, when detecting the trigger condition associated with the data stream, the processor is further configured to:
receive a request for a service deployed on the hardware accelerator.

19. The device of claim 18, wherein the service deployed on the hardware accelerator includes a Multi-Access Edge Computing (MEC) service associated with the base station.

20. A non-transitory computer-readable memory device, storing instructions executable by a processor, the non-transitory computer-readable memory device comprising:
one or more instructions to receive a data stream connection request via a WIFI connection or a wired connection;
one or more instructions to establish a cellular wireless connection with a base station based on the data stream connection request;
one or more instructions to determine a cellular wireless Quality of Service (QOS) class or network slice assigned to the cellular wireless connection by a core network associated with the base station;
one or more instructions to map the cellular wireless QoS class or network slice to a priority class associated with the WIFI connection or the wired connection;
one or more instructions to assign the priority class to a data stream associated with the data stream connection request; and
one or more instructions to process data units associated with the data stream based on the assigned priority class.
